(19) United States
(12) Patent Application Publication
(10) Pub. No.: US 2017/0171855 A1
(43) Pub. Date: Jun. 15, 2017

(54) NETWORK ASSISTANCE FOR DISTRIBUTED UNSCHEDULED TRANSMISSIONS

(71) Applicant: QUALCOMM Incorporated, San Diego, CA (US)

(72) Inventors: Jay Kumar Sundararajan, San Diego, CA (US); Jing Jiang, San Diego, CA (US); Tingfang Ji, San Diego, CA (US)

(21) Appl. No.: 15/191,370

(22) Filed: Jun. 23, 2016

Related U.S. Application Data
(60) Provisional application No. 62/266,524, filed on Dec. 11, 2015.

(51) Int. Cl. H04W 72/04; H04W 36/30; H04B 7/04

(52) U.S. Cl. CPC H04W 72/0413; H04W 72/042; H04B 7/0413; H04W 36/30

(57) ABSTRACT

Aspects of the present disclosure provide network assistance for distriuted unscheduled transmissions. A scheduling entity may provide unscheduled assistance information to a subordinate entity indicating a respective probability for use in selecting each resource from a subset of available resources for an unscheduled uplink transmissions. The subordinate entity may select at least one resource from the available resources for the unscheduled uplink transmission based on the unscheduled assistance information.

### PRIORITY CLAIM

The present Application for Patent claims priority to Provisional Application No. 62/266,524 entitled “Network Assistance for Distributed Unscheduled Transmissions” filed Dec. 11, 2015, and assigned to the assignee hereof and hereby expressly incorporated by reference herein.

### TECHNICAL FIELD

Aspects of the present disclosure relate generally to wireless communication systems, and more particularly, to distributed unscheduled uplink transmissions in wireless communication systems.

### BACKGROUND

Wireless communication networks are widely deployed to provide various communication services such as telephony, video, data, messaging, broadcasts, and so on. Such networks, which are usually multiple access networks, support communications for multiple users by sharing the available network resources.

The spectrum allocated to such wireless communication networks is typically apportioned between downlink transmissions from the base station to user equipment and uplink transmissions from the user equipment to the base station. Uplink transmissions in cellular systems typically operate in a scheduled mode utilizing a request-grant procedure, in which the user equipment transmits a scheduling request to the base station and the base station responds with a grant allowing the transmission.

However, the request-grant process may introduce delays in uplink transmissions, which may adversely impact delay-sensitive applications. An alternative approach to the request-grant procedure involves the user equipment initiating an uplink transmission without waiting for a grant, in a distributed unscheduled mode of operation. Such unscheduled transmissions, which may be distributed across time-frequency resources, may experience interference from ongoing scheduled transmissions or from other unscheduled transmissions.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure provide network assistance for distributed unscheduled transmissions, referred to herein as unscheduled uplink transmissions. A network device, such as a base station or other scheduling entity, may provide to one or more user equipment (UE), or other subordinate entities, unscheduled assistance information indicating a subset of available resources that are recommended for use in unscheduled uplink transmissions. The subordinate entity may utilize the unscheduled assistance information to select at least one resource from the available resources for an unscheduled uplink transmission. The unscheduled assistance information may include, for example, recommended time and/or frequency resources, recommended transmit power settings, recommended modulation and coding schemes, recommended multiple-input-multiple output (MIMO) pre-coding and rank choices and/or utilized resources in use for other uplink transmissions.

In one aspect, the disclosure provides a method for transmitting unscheduled uplink transmissions. The method includes receiving unscheduled assistance information from a scheduling entity that includes a respective probability for use in selecting each resource from a subset of available resources. The method further includes selecting at least one selected resource from the available resources for an unscheduled uplink transmission based on the unscheduled assistance information and transmitting the unscheduled uplink transmission using the at least one selected resource.

Another aspect of the disclosure provides a subordinate entity for communicating with a scheduling entity in a wireless communication network. The subordinate entity includes a wireless transceiver configured to communicate with the scheduling entity, a memory, and a processor communicatively coupled to the wireless transceiver and the memory. The processor is configured to determine available resources for communicating with the scheduling entity on an uplink carrier and to receive unscheduled assistance information from the scheduling entity via the wireless transceiver. The unscheduled assistance information includes a respective probability for use in selecting each resource from a subset of available resources. The processor is further configured to select at least one selected resource from the available resources for an unscheduled uplink transmission based on the unscheduled assistance information and transmit the unscheduled uplink transmission to the scheduling entity via the wireless transceiver utilizing the at least one selected resource.

Another aspect of the disclosure provides a subordinate entity apparatus for communicating with a scheduling entity in a wireless communication network. The subordinate entity apparatus includes means for receiving unscheduled assistance information from the scheduling entity. The unscheduled assistance information includes a respective probability for use in selecting each resource from a subset of available resources. The subordinate entity apparatus further includes means for selecting at least one selected resource from the available resources for an unscheduled uplink transmission based on the unscheduled assistance information and means for transmitting the unscheduled uplink transmission from the subordinate entity to the scheduling entity utilizing the at least one selected resource.

Another aspect of the disclosure provides a non-transitory computer-readable medium storing computer executable code, including code for receiving unscheduled assistance information from a scheduling entity, where the unscheduled assistance information includes a respective probability for use in selecting each resource from a subset of available resources, code for selecting at least one selected resource from the available resources for an unscheduled uplink transmission based on the unscheduled assistance information, and code for transmitting the unscheduled uplink transmission using the at least one selected resource.

Examples of additional aspects of the disclosure follow. In some aspects of the disclosure, the at least one selected resource includes at least one of a time slot, a frequency, a transmit power setting, a modulation and coding scheme or a MIMO beamforming setting.

In some aspects of the disclosure, the unscheduled assistance information may further include at least one of time resource information, frequency resource information, transmit power setting information, modulation and coding scheme information, or multiple-input-multiple-output (MIMO) pre-coding and rank choice information, etc. In some examples, the unscheduled assistance information includes a combination of at least two of the time resource information, the frequency resource information, the transmit power setting information, the modulation and coding scheme information, or the multiple-input-multiple-output (MIMO) pre-coding and rank choice information. In some aspects of the disclosure, the unscheduled assistance information further includes utilized resource information indicating uplink resources in use for at least one of other scheduled uplink transmissions or other unscheduled uplink transmissions.

In some aspects of the disclosure, the unscheduled assistance information indicates a respective probability for use in selecting one or more of time slots, frequencies, transmit power settings, modulation and coding schemes, or MIMO beamforming settings. In some examples, the unscheduled assistance information includes a non-uniform probability distribution. In some examples, the unscheduled assistance information indicates the respective probability for use in selecting each combination of two or more of time slots, frequencies, transmit power settings, modulation and coding schemes, or MIMO beamforming settings.

In some aspects of the disclosure, the method further includes receiving the unscheduled assistance information from the scheduling entity in a unicast message or a broadcast message. In some aspects of the disclosure, the method further includes receiving a respective control message including respective unscheduled assistance information in each subframe. In some aspects of the disclosure, the method further includes generating the unscheduled uplink transmission in response to determining that data to be transmitted to the scheduling entity relates to a mission critical application. In some aspects of the disclosure, the at least one selected resource is outside of the subset of available resources.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a network architecture.

FIG. 2 is a block diagram conceptually illustrating an example of a scheduling entity communicating with one or more subordinate entities according to some embodiments.

FIG. 3 is a block diagram illustrating an example of a hardware implementation for a scheduling entity employing a processing system according to some embodiments.

FIG. 4 is a block diagram illustrating an example of a hardware implementation for a subordinate entity employing a processing system according to some embodiments.

FIG. 5 is a diagram illustrating an example of scheduled and unscheduled uplink transmissions utilizing time-frequency resources that may collide.

FIG. 6 is a diagram illustrating an example of scheduled and unscheduled uplink transmissions utilizing time-frequency resources selected based on unscheduled assistance information.

FIG. 7 is a diagram illustrating an example of unscheduled uplink transmissions utilizing time resources that may collide.

FIG. 8 is a diagram illustrating an example of unscheduled uplink transmissions utilizing time resources selected based on unscheduled assistance information.

FIG. 9 is a diagram illustrating an example of a probability distribution of recommended frequency resources.

FIG. 10 is a flow chart of a method for facilitating unscheduled uplink transmissions utilizing unscheduled assistance information.

FIG. 11 is a flow chart of a method for unscheduled uplink transmissions based on unscheduled assistance information.

FIG. 12 is a flow chart of another method for unscheduled uplink transmissions based on unscheduled assistance information.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

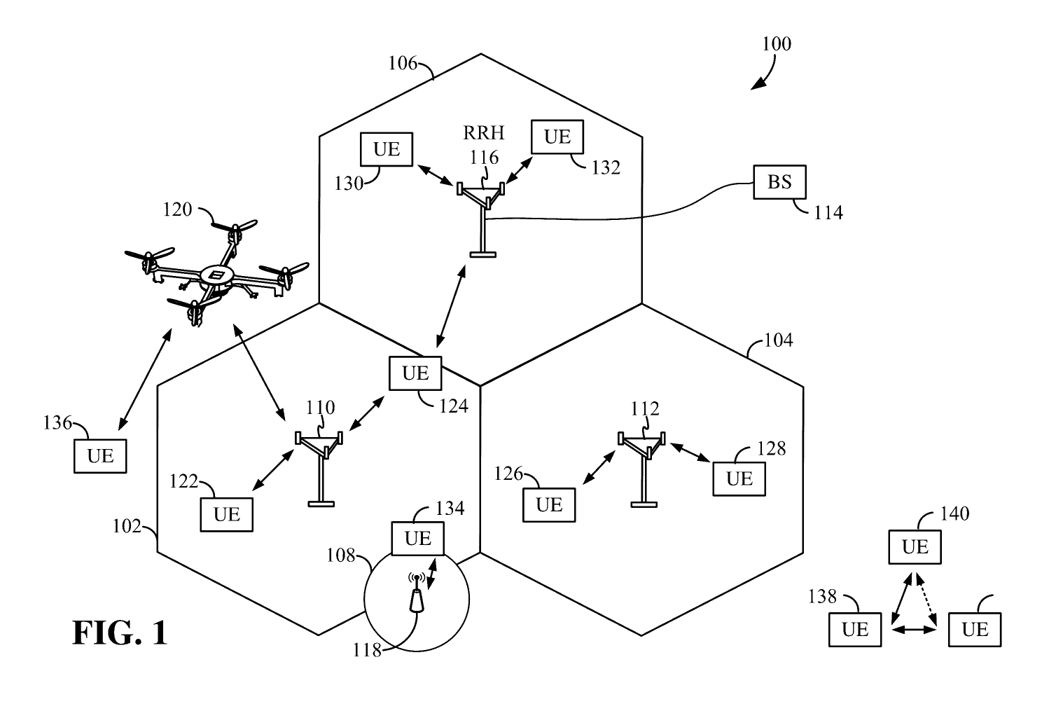

The various concepts presented throughout this disclosure may be implemented across a broad variety of telecommunication systems, network architectures, and communication standards. Referring now to FIG. 1, as an illustrative example without limitation, a simplified schematic illustration of an access network 100 is provided.

The geographic region covered by the access network 100 may be divided into a number of cellular regions (cells), including macrocells 102, 104, and 106, and a small cell 108, each of which may include one or more sectors. Cells may be defined geographically (e.g., by coverage area) and/or may be defined in accordance with a frequency, scrambling code, etc. In a cell that is divided into sectors, the multiple sectors within a cell can be formed by groups of antennas with each antenna responsible for communication with mobile devices in a portion of the cell.

In general, a radio transceiver apparatus serves each cell. A radio transceiver apparatus is commonly referred to as a base station (BS) in many wireless communication systems, but may also be referred to by those skilled in the art as a base transceiver station (BTS), a radio base station, a radio transceiver, a transceiver function, a basic service set (BSS), an extended service set (ESS), an access point (AP), a Node B, an eNode B, or some other suitable terminology.

In FIG. 1, two high-power base stations 110 and 112 are shown in cells 102 and 104; and a third high-power base station 114 is shown controlling a remote radio head (RRH) 116 in cell 106. In this example, the cells 102, 104, and 106 may be referred to as macrocells, as the high-power base stations 110, 112, and 114 support cells having a large size. Further, a low-power base station 118 is shown in the small cell 108 (e.g., a microcell, picocell, femtocell, home base station, home Node B, home eNode B, etc.) which may overlap with one or more macrocells. In this example, the cell 108 may be referred to as a small cell, as the low-power base station 118 supports a cell having a relatively small size. Cell sizing can be done according to system design as well as component constraints. It is to be understood that the access network 100 may include any number of wireless base stations and cells. The base stations 110, 112, 114, 118 provide wireless access points to a core network for any number of mobile apparatuses.

FIG. 1 further includes a quadcopter or drone 120, which may be configured to function as a base station. That is, in some examples, a cell may not necessarily be stationary, and the geographic area of the cell may move according to the location of a mobile base station such as the quadcopter 120.

In some examples, the base stations may be interconnected to one another and/or to one or more other base stations or network nodes (not shown) in the access network 100 through various types of backhaul interfaces such as a direct physical connection, a virtual network, or the like using any suitable transport network.

The access network 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

Within the present document, a “mobile” apparatus need not necessarily have a capability to move, and may be stationary. Some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, and a personal digital assistant (PDA). A mobile apparatus may additionally be an “Internet of things” (IoT) device such as an automotive or other transportation vehicle, a satellite radio, a global positioning system (GPS) device, a logistics controller, a drone, a multi-copter, a quad-copter, a smart energy or security device, municipal lighting, water, or other infrastructure; industrial automation and enterprise devices; consumer and wearable devices, such as eyewear, a wearable camera, a smart watch, a health or fitness tracker, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc.

Within the access network 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with low-power base station 118; and UE 136 may be in communication with mobile base station 120. Here, each base station 110, 112, 114, 118, and 120 may be configured to provide an access point to a core network (not shown) for all the UEs in the respective cells.

In another example, the quadcopter 120 may be configured to function as a UE. For example, the quadcopter 120 may operate within cell 102 by communicating with base station 110.

The air interface in the access network 100 may utilize one or more multiplexing and multiple access algorithms to enable simultaneous communication of the various devices. For example, multiple access for uplink (UL) or reverse link transmissions from UEs 122 and 124 to base station 110 may be provided utilizing time division multiple access (TDMA), code division multiple access (CDMA), frequency division multiple access (FDMA), orthogonal frequency division multiple access (OFDMA), or other suitable multiple access schemes. Further, multiplexing downlink (DL) or forward link transmissions from the base station 110 to UEs 122 and 124 may be provided utilizing time division multiplexing (TDM), code division multiplexing (CDM), frequency division multiplexing (FDM), orthogonal frequency division multiplexing (OFDM), or other suitable multiplexing schemes.

Within the access network 100, during a call with a scheduling entity, or at any other time, a UE may monitor various parameters of the signal from its serving cell as well as various parameters of neighboring cells. Further, depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In some examples, access to the air interface may be scheduled, in which a scheduling entity (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

In various aspects of the disclosure, some applications may be delay-sensitive and may also require high reliability, referred to hereafter as mission critical applications. For example, some applications may have delay and reliability requirements that may not be met using a scheduled mode of operation. Such mission critical applications may utilize an unscheduled mode of operation in which uplink transmissions are transmitted without waiting for a grant of resources. In some examples, a scheduling request may be sent in parallel with the unscheduled transmission to provide for a grant of resources for a retransmission, if necessary.

Base stations are not the only entities that may function as a scheduling entity. That is, in some examples, a UE may function as a scheduling entity, scheduling resources for one or more subordinate entities (e.g., one or more other UEs). For example, UE 138 is illustrated communicating with UEs 140 and 142. In this example, the UE 138 is functioning as a scheduling entity, and UEs 140 and 142 utilize resources scheduled by the UE 138 for wireless communication. A UE may function as a scheduling entity in a peer-to-peer (P2P) network, and/or in a mesh network. In a mesh network example, UEs 140 and 142 may optionally communicate directly with one another in addition to communicating with the scheduling entity 138.

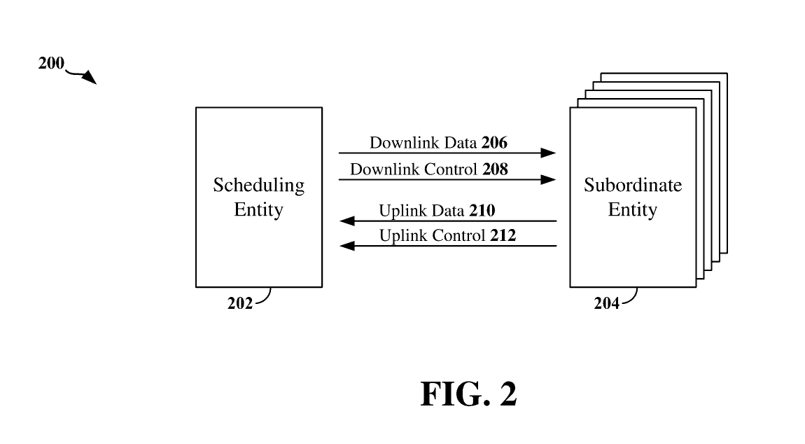

Thus, in a wireless communication network with a scheduled access to time-frequency resources and having a cellular configuration, a P2P configuration, or a mesh configuration, a scheduling entity and one or more subordinate entities may communicate utilizing the scheduled resources. Referring now to FIG. 2, a block diagram illustrates a scheduling entity 202 and a plurality of subordinate entities 204. Here, the scheduling entity 202 may correspond to the base stations 110, 112, 114, and 118. In additional examples, the scheduling entity 202 may correspond to the UE 138, the quadcopter 120, or any other suitable node in the access network 100. Similarly, in various examples, the subordinate entity 204 may correspond to the UE 122, 124, 126, 128, 130, 132, 134, 136, 138, 140, and 142, or any other suitable node in the access network 100.

As illustrated in FIG. 2, the scheduling entity 202 may broadcast data 206 to one or more subordinate entities 204 (the data may be referred to as downlink data). In accordance with certain aspects of the present disclosure, the term downlink (DL) may refer to a point-to-multipoint transmission originating at the scheduling entity 202. Broadly, the scheduling entity 202 is a node or device responsible for scheduling traffic in a wireless communication network, including the downlink transmissions and, in some examples, uplink data 210 from one or more subordinate entities to the scheduling entity 202. Another way to describe the system may be to use the term broadcast channel multiplexing. In accordance with aspects of the present disclosure, the term uplink (UL) may refer to a point-to-point transmission originating at a subordinate entity 204. Broadly, the subordinate entity 204 is a node or device that receives scheduling control information, including but not limited to scheduling grants, synchronization or timing information, or other control information from another entity in the wireless communication network such as the scheduling entity 202.

The scheduling entity 202 may broadcast a control channel 208 to one or more subordinate entities 204. In some examples, the control channel 208 may be a Primary Synchronization Signal (PSS), Secondary Synchronization Signal, Physical Broadcast Channel (PBCH) or a Physical Downlink Control Channel (PDCCH) (or Enhanced PDCCH (EPDCCH)). The PSS carries information on the carrier frequency and subframe timing, the SSS carries information on the frame timing, the PBCH carries the Master Information Block (MIB) including channel bandwidth information and the PDCCH carries uplink power information and resource allocations for uplink and downlink data. Resource configuration information may further be included in one or more Session Information Blocks (SIBs) that may be carried on a Physical Downlink Shared Channel (PDSCH) that further carries downlink data.

Uplink data 210 and/or downlink data 206 may be transmitted using a transmission time interval (TTI). Here, a TTI may correspond to an encapsulated set or packet of information capable of being independently decoded. In various examples, TTIs may correspond to frames, subframes, resource blocks, time slots, or other suitable groupings of bits for transmission.

Furthermore, the subordinate entities 204 may transmit uplink control information 212 to the scheduling entity 202. Uplink control information may include a variety of packet types and categories, including pilots, reference signals, and information configured to enable or assist in decoding uplink data transmissions. In some examples, the control information 212 may include a scheduling request (SR), i.e., request for the scheduling entity 202 to schedule uplink transmissions. Here, in response to the SR transmitted on the control channel 212, the scheduling entity 202 may transmit in the downlink control channel 208 information that may schedule the TTI for uplink packets. In a further example, the uplink control channel 212 may include hybrid automatic repeat request (HARQ) feedback transmissions, such as an acknowledgment (ACK) or negative acknowledgment (NACK). HARQ is a technique well-known to those of ordinary skill in the art, wherein packet transmissions may be checked at the receiving side for accuracy, and if confirmed, an ACK may be transmitted, whereas if not confirmed, a NACK may be transmitted. In response to a NACK, the transmitting device may send a HARQ retransmission, which may implement chase combining, incremental redundancy, etc.

The channels illustrated in FIG. 2 are not necessarily all of the channels that may be utilized between a scheduling entity 202 and subordinate entities 204, and those of ordinary skill in the art will recognize that other channels may be utilized in addition to those illustrated, such as other data, control, and feedback channels.

In an aspect of the disclosure, the subordinate entity 204 may further transmit unscheduled uplink transmissions (control and/or data) to the scheduling entity 202 in an unscheduled mode of operation. In the unscheduled mode of operation, the subordinate entity 204 generates and transmits information on an uplink subcarrier without waiting for a grant of resources from the scheduling entity 202. The subordinate entity 204 may operate in the unscheduled mode of operation for various reasons. For example, the request-grant transaction may introduce delays in uplink transmission, which may adversely impact the requirements of various mission critical applications that are delay-sensitive and/or require high reliability. Thus, the subordinate entity 204 may transmit such mission critical data to the scheduling entity 202 in unscheduled uplink transmissions.

However, the subordinate entity 204 attempting an unscheduled uplink transmission may not have any information on which time-frequency resources are already allocated for other scheduled or unscheduled transmissions. In addition, the subordinate entity 204 may not be aware of the transmit power needed to overcome the interference from and/or reduce the impact on other uplink transmissions. The subordinate entity 204 may also not be aware of which multiple-input-multiple-output (MIMO) beamforming settings are preferable in view of other uplink transmissions and the channel state. Thus, unscheduled uplink transmissions may experience significant interference from ongoing scheduled transmissions or from other unscheduled transmissions, requiring a retransmission of the mission critical data, which could result in unacceptable delays in such transmissions.

Therefore, in accordance with aspects of the present disclosure, the scheduling entity 202 may provide unscheduled assistance information on, for example, a DL control channel 208, to the subordinate entity 204 indicating one or more resources recommended for use in unscheduled uplink transmissions. As used herein, the term “resource” refers to a time slot, frequency, transmit power setting, modulation and coding scheme and/or multiple-input-multiple-output (MIMO) pre-coding and rank choice. Thus, the unscheduled assistance information may indicate, for example, one or more time slots, frequencies, transmit power settings, modulation and coding schemes and/or MIMO beamforming settings recommended for use in unscheduled uplink transmissions. The subordinate entity 204 may then use this unscheduled assistance information to select resources for an unscheduled transmission in order to avoid collisions with other uplink transmissions or to mitigate the effects of any such collision. For example, the subordinate entity 204 may select a resource that the scheduling entity has not assigned to any other scheduled uplink transmission. As another example, the subordinate entity 204 may select a resource that is assigned to another subordinate entity near the scheduling entity 202, which may enable the scheduling entity 202 to perform interference cancellation of the nearby subordinate entity such that the unscheduled uplink transmission is not impacted by the collision.

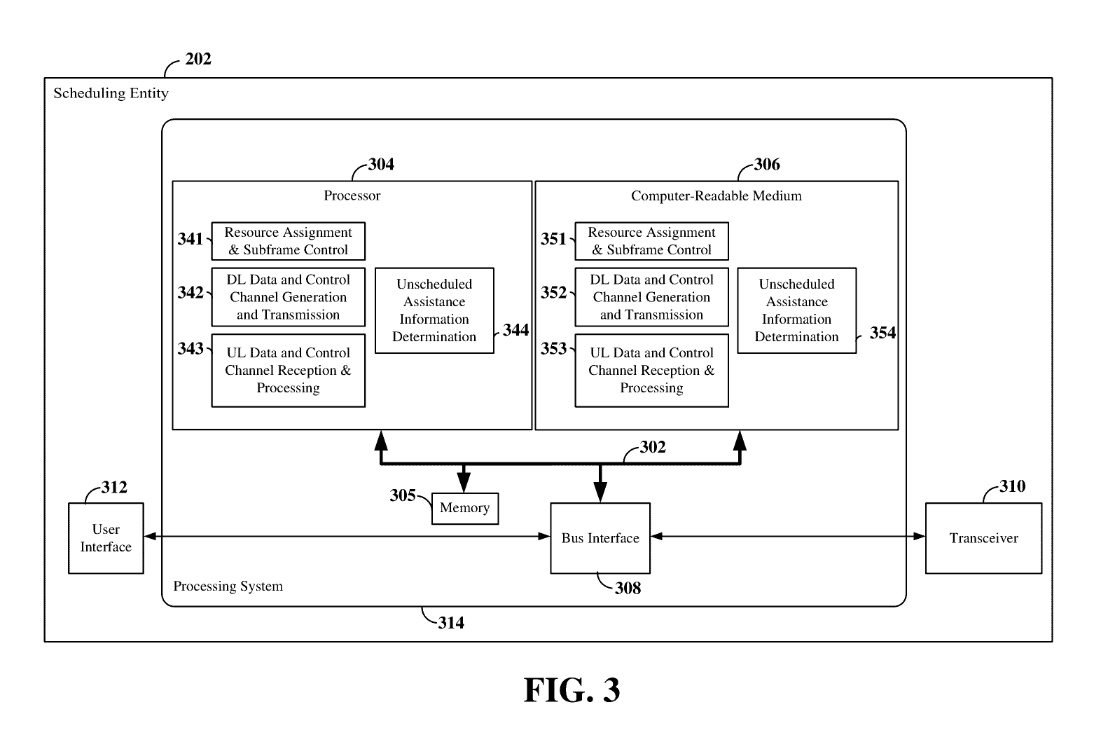

FIG. 3 is a conceptual diagram illustrating an example of a hardware implementation for a scheduling entity 300 employing a processing system 314. For example, the scheduling entity 300 may be a user equipment (UE) as illustrated in any one or more of FIG. 1 or 2. In another example, the scheduling entity 300 may be a base station as illustrated in any one or more of FIG. 1 or 2.

The scheduling entity 300 may be implemented with a processing system 314 that includes one or more processors 304. Examples of processors 304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 400 may be configured to perform any one or more of the functions described herein. That is, the processor 304, as utilized in a scheduling entity 300, may be used to implement any one or more of the processes described below.

In this example, the processing system 314 may be implemented with a bus architecture, represented generally by the bus 302. The bus 302 may include any number of interconnecting buses and bridges depending on the specific application of the processing system 314 and the overall design constraints. The bus 302 links together various circuits including one or more processors (represented generally by the processor 304), a memory 305, and computer-readable media (represented generally by the computer-readable medium 306). The bus 302 may also link various other circuits such as timing sources, peripherals, voltage regulators, and power management circuits, which are well known in the art, and therefore, will not be described any further. A bus interface 308 provides an interface between the bus 302 and a transceiver 310. The transceiver 310 provides a means for communicating with various other apparatus over a transmission medium. Depending upon the nature of the apparatus, a user interface 312 (e.g., keypad, display, touch screen, speaker, microphone, joystick) may also be provided.

The processor 304 is responsible for managing the bus 302 and general processing, including the execution of software stored on the computer-readable medium 306. The software, when executed by the processor 304, causes the processing system 314 to perform the various functions described below for any particular apparatus. The computer-readable medium 306 may also be used for storing data that is manipulated by the processor 304 when executing software.

One or more processors 304 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 306. The computer-readable medium 306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 306 may reside in the processing system 314, external to the processing system 314, or distributed across multiple entities including the processing system 314. The computer-readable medium 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 304 may include resource assignment and subframe control circuitry 341, configured to generate, schedule, and modify a resource assignment or grant of time-frequency resources. For example, the resource assignment and subframe control circuitry 341 may generate one or more subframes, each including time-frequency resources assigned to carry data and/or control information to and/or from multiple subordinate entities. The resource assignment and subframe control circuitry 341 may operate in coordination with resource assignment and subframe control software 351.

The processor 304 may further include downlink (DL) data and control channel generation and transmission circuitry 342, configured to generate and transmit downlink data and control channels. The DL data and control channel generation and transmission circuitry 342 may operate in coordination with the resource assignment and subframe control circuitry 341 to schedule the DL data and/or control information and to place the DL data and/or control information onto a carrier, such as a time division duplex (TDD) carrier or a frequency division duplex (FDD) carrier, within one or more subframes generated by the resource assignment and subframe control circuitry 341 in accordance with the resources assigned to the DL data and/or control information. The DL data and control channel generation and transmission circuitry 342 may further operate in coordination with DL data and control channel generation and transmission software 352.

The processor 304 may further include uplink (UL) data and control channel reception and processing circuitry 343, configured to receive and process uplink control channels and uplink data channels from one or more subordinate entities. In some examples, the UL data and control channel reception and processing circuitry 343 may be configured to receive scheduling requests from one or more subordinate entities, the scheduling requests being configured to request a grant of time-frequency resources for uplink user data transmissions. In other examples, the UL data and control channel reception and processing circuitry 343 may be configured to receive and process acknowledgement information (e.g., acknowledged/not acknowledged packets) from one or more subordinate entities. The UL data and control channel reception and processing circuitry 343 may operate in coordination with the resource assignment and subframe control circuitry 341 to schedule UL data transmissions, DL data transmissions and/or DL data retransmissions in accordance with the received UL control channel information. The UL data and control channel reception and processing circuitry 343 may further operate in coordination with UL data and control channel reception and processing software 353.

The processor 304 may further include unscheduled assistance information determination circuitry 344, configured for determining unscheduled assistance information indicating at least one resource recommended for use by one or more subordinate entities in distributed unscheduled uplink transmissions. For example, the unscheduled assistance information may identify a subset of the resources available for use in uplink transmissions and that are recommended for subordinate entities to use when generating and transmitting unscheduled uplink transmissions. As used herein, the term “available resources” refers to the time slots, frequencies, transmit power settings, modulation and coding schemes, MIMO beamforming settings and other resources that the subordinate entity (UE) may utilize in uplink transmissions towards the scheduling entity.

In some examples, the unscheduled assistance information may include a probability distribution of the subset of resources recommended for use in unscheduled uplink transmissions. The probability distribution indicates a respective probability that the subordinate entity will select each resource from the subset of available resources. All resources that have a non-zero probability are included in the recommended subset of available resources. In one example, the probability distribution may include multiple probability distributions, each corresponding to a particular resource (e.g., time slots, frequencies, transmit power settings, modulation and coding schemes, MIMO beamforming settings, etc.). In another example, the probability distribution may represent a combination of two or more resources (i.e., each probability is associated with a particular combination of two or more resources).

For example, the probability distribution may assign a non-zero probability to each recommended frequency/frequency band that the subordinate entity will select a frequency resource from that frequency/frequency band. In some examples, the probability distribution may be a non-uniform distribution that prioritizes different bandwidth regions differently. In some examples, the probability distribution indicates the respective probability that the subordinate entity will select each combination of two or more recommended resources. For example, the probability distribution may include both frequencies/frequency bands and time slots for each frequency/frequency band. The probability distribution may further indicate spatial resources for each frequency/frequency band. As another example, the probability distribution may indicate a respective non-zero probability that the subordinate entity will select each transmit power setting, modulation and coding scheme, and/or MIMO beamforming setting. The probability distribution may further indicate the non-zero probability that the subordinate entity will select each transmit power setting, modulation and coding scheme and/or MIMO beamforming setting for each frequency/frequency band and/or time slot.

In some examples, the unscheduled assistance information determination circuitry 344 determines the probability distribution based on the frequencies (or frequency bands) currently in use for other scheduled or unscheduled uplink transmissions. For example, if frequencies f₁ and f₂ are currently in use for other scheduled or unscheduled uplink transmissions, the unscheduled assistance information determination circuitry 344 may assign a low probability to frequencies f₁ and f₂, whereas if frequencies f₃ and f₄ are not currently in use, the unscheduled assistance information determination circuitry 344 may assign a high probability to frequencies f₃ and f₄. Any frequencies assigned a non-zero probability are included in the subset of recommended frequencies, though some frequencies may be “less” recommended if the assigned probability is low.

The unscheduled assistance information determination circuitry 344 may further consider the quality of the link, the likelihood that a particular time/frequency resource may be utilized, the loading level on each frequency/frequency band and/or other factors when assigning a particular probability to each resource. In addition, a different probability distribution may be determined for each subordinate entity to reduce the possibility of collisions between unscheduled uplink transmissions.

In addition to or in alternative to a probability distribution for one or more resources, the unscheduled assistance information may further include time resource information, frequency resource information, transmit power setting information, modulation and coding scheme information, multiple-input-multiple-output (MIMO) pre-coding and rank choice information and/or utilized resource information. For example, the time resource information may indicate one or more recommended time slots at which unscheduled uplink transmissions should begin on one or more frequencies (or frequency bands). In an aspect, the unscheduled assistance information determination circuitry 344 may determine when a scheduled uplink transmission will end, and recommend a next available time slot following the scheduled uplink transmission for use for unscheduled uplink transmissions.

As another example, the frequency resource information may indicate one or more frequencies (or frequency bands) recommended for unscheduled uplink transmissions. The recommended frequencies/frequency bands may be statically configured, such that a block of frequencies may be reserved for primarily unscheduled uplink transmissions, or may be dynamically configured, based on the current frequency resource usage. In an aspect, the unscheduled assistance information determination circuitry 344 may divide the available bandwidth into frequency blocks and compare the number of frequencies in use within each frequency block to a threshold value. If the number of frequencies/frequency bands in use within a particular frequency block compares favorably with the threshold value (i.e., the number of frequencies/frequency bands in use is less than the threshold value), the particular frequency block may be recommended for use in unscheduled uplink transmissions.

As another example, the transmit power setting information may indicate a particular transmit power recommended for unscheduled uplink transmissions. The recommended transmit power may serve to overcome interference from and/or reduce the impact upon other scheduled and/or unscheduled transmissions. The recommended transmit power may be determined based on the processing capabilities of the UL data and control channel reception and processing circuitry 343. For example, the recommended transmit power may be determined based on whether the UL data and control channel reception and processing circuitry 343 is capable of performing interference cancellation.

As another example, the modulation and coding scheme information may indicate one or more recommended modulation and coding schemes (MCSs) to utilize for unscheduled uplink transmissions. Each MCS may indicate, for example, a particular modulation type (e.g., BPSK, QPSK, 16-QAM or 64-QAM), together with a particular coding rate (e.g., 1/2, 2/3, 3/4, 5/6, etc.) for a particular number of spatial streams. In an aspect, the unscheduled assistance information determination circuitry 344 may recommend a lower MCS to compensate for the impact of interference.

As another example, the MIMO pre-coding and rank choice information may indicate one or more recommended MIMO pre-coding and rank choices to utilize for unscheduled uplink transmissions. Each MIMO pre-coding and rank choice may indicate, for example, a number of streams to be transmitted (i.e., the rank) and an entry within a predefined codebook providing the pre-coding to be applied to each stream. For example, each codebook entry may indicate specific weights (phase and amplitude) to be applied to each stream and may further map each stream to an antenna. The recommended MIMO pre-coding and rank choices may be utilized by subordinate entities to create a MIMO beamforming direction that minimizes interference. In an aspect, the recommended MIMO pre-coding and rank choices may be selected by the unscheduled assistance information determination circuitry 344 based on ongoing scheduled and/or unscheduled transmissions. The recommended MIMO pre-coding and rank choices may also be individually selected for each subordinate entity based on the respective current channel states.

As another example, the utilized resource information may indicate uplink resources currently in use for other uplink transmissions. In some examples, the utilized resource information may indicate one or more frequency bands (i.e., frequency subcarriers) and/or one or more time slots to avoid using for unscheduled uplink transmissions. By indicating one or more resources to avoid for unscheduled uplink transmissions, the utilized resource information thereby implicitly indicates one or more resources recommended for use in unscheduled uplink transmissions (e.g., time/frequency resources that are currently not in use). In an aspect, the unscheduled assistance information determination circuitry 344 may determine one or more time-frequency resources currently in use for scheduled and/or unscheduled uplink transmissions and recommend that subordinate entities avoid using those resources when sending unscheduled uplink control information and/or data. For example, the unscheduled assistance information determination circuitry 344 may divide the available bandwidth into frequency blocks and compare the number of frequencies/frequency bands in use within each frequency block to a threshold value. If the number of frequencies/frequency bands in use within a particular frequency block compares unfavorably with the threshold value (i.e., the number of frequencies/frequency bands in use exceeds the threshold value), the unscheduled assistance information determination circuitry 344 may recommend avoiding using that particular frequency block in unscheduled uplink transmissions (thereby implicitly recommending using other frequency blocks in unscheduled uplink transmissions).

The unscheduled assistance information may further include a combination of two or more of the time resource information, the frequency resource information, the transmit power setting information, the modulation and coding scheme information, the MIMO pre-coding and rank choice information and the utilized resource information. For example, the unscheduled assistance information may recommend different power settings for different frequency bands.

The unscheduled assistance information determination circuitry 344 may further exchange unscheduled assistance information with other scheduling entities (e.g., utilizing inter-cell signaling) to coordinate the unscheduled assistance information among cells and avoid inter-cell interference. In some examples, the unscheduled assistance information may include recommended frequencies for unscheduled uplink transmissions that are statically configured among multiple scheduling entities.

The unscheduled assistance information determination circuitry 344 may further provide the unscheduled assistance information to the DL data and control channel generation and transmission circuitry 342 for inclusion of the unscheduled assistance information in a control message transmitted on a downlink control channel (e.g., the PDCCH or EPDCCH). The message may be a unicast message (e.g., a message having a particular subordinate entity as the destination) or a broadcast message. The message may further be transmitted in a dynamic manner (e.g., each subframe) or in a semi-static manner (e.g., as part of semi-persistent scheduling information or along the timeframe of radio resource control messages). For example, each subframe may include a respective control message containing respective unscheduled assistance information, which may be the same as or different from the unscheduled assistance information included in the previous subframe. The unscheduled assistance information determination circuitry 344 may operate in coordination with distributed unscheduled assistance information determination software 354.

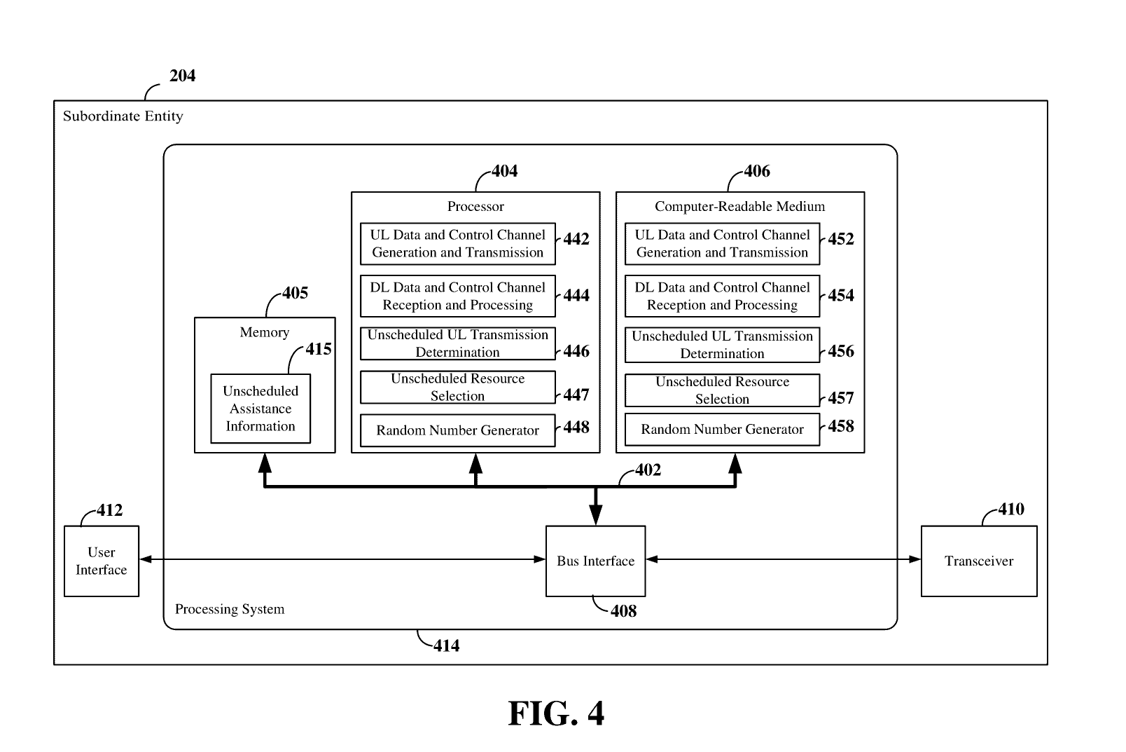

FIG. 4 is a conceptual diagram illustrating an example of a hardware implementation for an exemplary subordinate entity 400 employing a processing system 414. In accordance with various aspects of the disclosure, an element, or any portion of an element, or any combination of elements may be implemented with a processing system 414 that includes one or more processors 404. For example, the subordinate entity 400 may be a user equipment (UE) as illustrated in any one or more of FIG. 1 or 2.

The processing system 414 may be substantially the same as the processing system 314 illustrated in FIG. 3, including a bus interface 408, a bus 402, memory 405, a processor 404, and a computer-readable medium 406. Furthermore, the subordinate entity 204 may include a user interface 412 and a transceiver 410 substantially similar to those described above in FIG. 3. The processor 404, as utilized in a subordinate entity 204, may be used to implement any one or more of the processes described below.

In some aspects of the disclosure, the processor 404 may include uplink (UL) data and control channel generation and transmission circuitry 442, configured to generate and transmit uplink data on an UL data channel within one or more subframes of an uplink carrier, and to generate and transmit uplink control/feedback/acknowledgement information on an UL control channel within one or more subframes of the uplink carrier. The uplink carrier may be, for example, a time division duplex (TDD) carrier or a frequency division duplex (FDD) carrier. The UL data and control channel generation and transmission circuitry 442 may operate in coordination with UL data and control channel generation and transmission software 452.

The processor 404 may further include downlink (DL) data and control channel reception and processing circuitry 444, configured for receiving and processing downlink data on a data channel, and to receive and process control information on one or more downlink control channels. In an aspect, the control information may include unscheduled assistance information 415. In some examples, received downlink data and/or control information, such as unscheduled assistance information 415, may be stored within memory 405. The DL data and control channel reception and processing circuitry 444 may operate in coordination with DL data and control channel reception and processing software 454.

The processor 404 may further include unscheduled UL transmission determination circuitry 446, configured for determining whether to generate and transmit an unscheduled uplink transmission. For example, uplink data may be received from a mission critical application, such as a control application related to a drone or robot, which has delay and reliability requirements that may not be met using a scheduled mode of operation. Upon receiving the mission critical uplink data, the unscheduled UL transmission determination circuitry 446 may determine that the mission critical uplink data should be transmitted in an unscheduled uplink transmission (e.g., without waiting for a grant of resources from the scheduling entity). The unscheduled UL transmission determination circuitry 446 may then coordinate with the UL data and control channel generation and transmission circuitry 442 to generate an unscheduled uplink transmission including the mission critical uplink data. In some examples, a scheduling request may be sent in parallel with the unscheduled uplink transmission to provide for a grant of resources for a retransmission, if necessary.

The processor 404 may further include unscheduled resource selection circuitry 447, configured for coordinating with the unscheduled UL transmission and generation circuitry 446 to select one or more resources for an unscheduled uplink transmission via the UL data and control channel generation and transmission circuitry 442. In an aspect of the disclosure, the selected resource(s) may include a time slot, a frequency, a transmit power setting, a modulation and coding scheme and/or a MIMO beamforming setting. The unscheduled resource selection circuitry 447 may select the selected resource(s) from available uplink resources based on the unscheduled assistance information 415. The available uplink resources include all resources (e.g., time slots, frequencies, transmit power settings, modulation and coding schemes and MIMO beamforming settings) available to the subordinate entity for use in uplink transmissions, which may be scheduled or unscheduled. The available uplink resources may be determined, for example, based on control information received from the scheduling entity (e.g., time-frequency resource information provided in the synchronization signals and/or within the MIB and/or SIB s), a predefined code book containing MIMO precoding and rank choices maintained by the scheduling entity and subordinate entity, modulation and coding scheme (MCS) options maintained by the scheduling entity and subordinate entity and uplink transmit power setting options maintained by the scheduling entity and subordinate entity. The unscheduled assistance information 415 identifies a subset of the available resources recommended for use in unscheduled uplink transmissions.

In some examples, the unscheduled resource selection circuitry 447 may receive the unscheduled assistance information 415 from the DL data and control channel reception and processing circuitry 444 or retrieve the unscheduled assistance information 415 from the memory 405, and select the one or more resources for the unscheduled uplink transmission based on the unscheduled assistance information 415. In some examples, the unscheduled assistance information includes one or more probability distributions, each for one or more resources, and the unscheduled resource selection circuitry 447 selects the resource(s) to be used for the unscheduled transmission randomly according to the probability distribution. For example, the unscheduled resource selection circuitry 447 may utilize random number generator circuitry 448 programmed in accordance with the received probability distribution to select one or more resources. In an example, the probability distribution may indicate the following probabilities for each of four frequencies (f₁-f₄):

f₁=10%

f₂=10%

f₃=40%

f₄=40%

The unscheduled resource selection circuitry 447 may program the random number generator circuitry 448 such that the random number generator circuitry 448 randomly selects frequency f₁ 10% of the time, frequency f₂ 10% of the time, frequency f₃ 40% of the time and frequency f₄ 40% of the time. In some examples, the unscheduled resource selection circuitry 447 may select a resource having a zero probability (i.e., a resource not included in the subset of recommended resources) based on the type of data being transmitted (i.e., more urgent data may be transmitted without utilizing the probability distribution information), the measured interference on one or more frequencies or other factors.

In addition to or in alternative to a probability distribution for one or more resources, the unscheduled assistance information may further include time resource information, frequency resource information, transmit power setting information, modulation and coding scheme information, multiple-input-multiple-output (MIMO) pre-coding and rank choice information and/or utilized resource information. Based on the unscheduled assistance information, the unscheduled resource selection circuitry 447 may select a recommended frequency and/or time slot or select a frequency and/or time slot not currently in use for the unscheduled uplink transmission. As another example, the unscheduled resource selection circuitry 447 may select a recommended transmit power setting, but utilize a time slot and/or frequency not recommended for use in unscheduled uplink transmissions. Thus, although the unscheduled resource selection circuitry 447 may consider the unscheduled assistance information 415 when selecting resource(s) for an unscheduled uplink transmission, the unscheduled resource selection circuitry 447 is not limited to the recommended resources in the unscheduled assistance information.

The unscheduled resource selection circuitry 447 may operate in coordination with unscheduled resource selection software 457. In addition, the random number generator circuitry 337 may operate in coordination with random number generator software 458.

One or more processors 404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 406 may reside in the processing system 414, external to the processing system 414, or distributed across multiple entities including the processing system 414. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

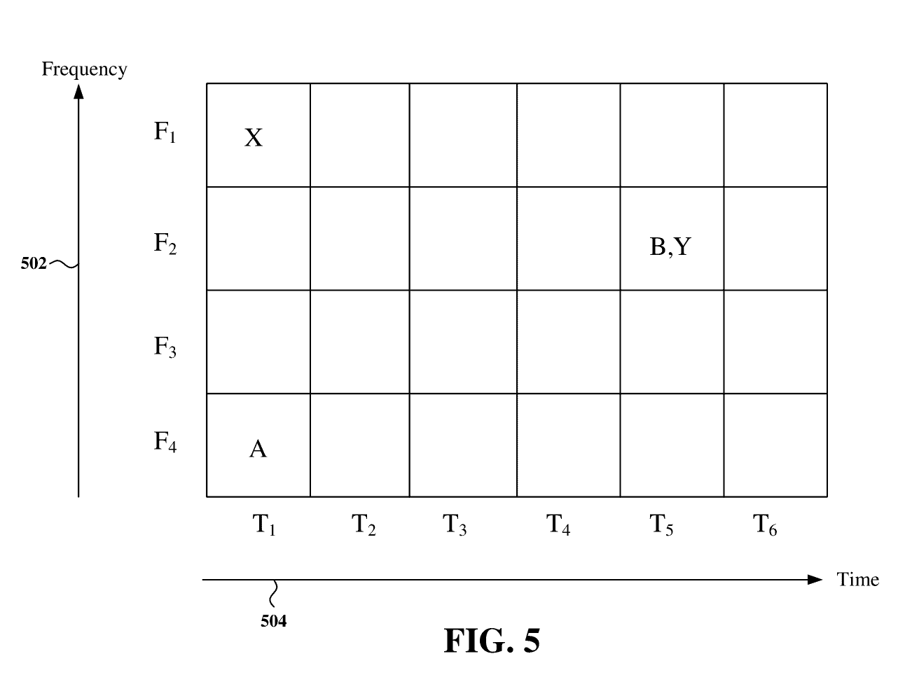

FIG. 5 is a diagram illustrating an example of scheduled and distributed unscheduled uplink transmissions utilizing time-frequency resources that may collide. In FIG. 5, time is illustrated in the horizontal direction, while frequency is illustrated in the vertical direction. For simplicity, the time resources are illustrated as being divided into six time slots, while the frequency resources are illustrated as being divided into four subcarriers. The resulting time-frequency resources form a grid of resource elements, with each resource element corresponding to a particular time slot and frequency.

In the example shown in FIG. 5, packets X and Y are generated and transmitted by a first user equipment (UE1), while packets A and B are generated and transmitted by a second UE (UE2). In addition, UE1 is operating in a scheduled transmission mode, in which packets are transmitted on a resource granted by the base station in a grant message. However, in this example UE2 is operating in an unscheduled mode, in which packets are transmitted on random resources. For example, UE2 may select one of the four frequency resources 502 (F₁, F₂, F₃ or F₄) randomly in a distributed manner over time 504 (with time slots T₁-T₆ being illustrated for simplicity) for transmission of packets A and B.

In the example shown in FIG. 5, during time slot T₁, UE1 is scheduled to transmit packet X over frequency F₁. UE2 further randomly selects frequency F₄ during time slot T₁ for transmission of packet A. Since each packet (packets A and X) is transmitted over a different frequency, collision of packets A and X does not occur. However, during time slot T₅, UE1 is scheduled to transmit packet Y over frequency F₂, and UE2 further randomly selects frequency F₂ to transmit packet B. Thus, packets B and Y collide, which may impact the decoding of the packets at the base station (scheduling entity).

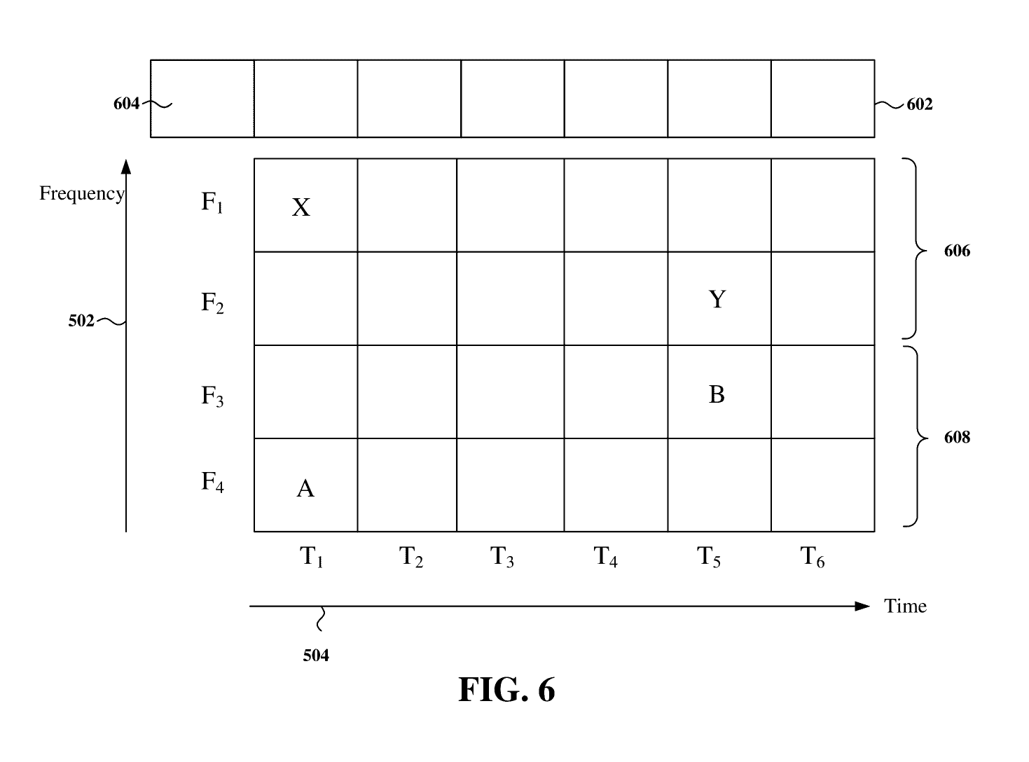

FIG. 6 is a diagram illustrating an example of scheduled and unscheduled uplink transmissions utilizing time-frequency resources selected based on unscheduled assistance information. In the example shown in FIG. 6, packets X and Y are again generated and transmitted by UE1 operating in a scheduled mode, while packets A and B are generated and transmitted by UE2 operating in an unscheduled mode. However, as shown in FIG. 6, the base station transmits a control message 604 including unscheduled assistance information on a control channel 602 to the UEs (UE1 and UE2) indicating that UEs should use only frequency resources F₃ and F₄ for grant-less (distributed unscheduled) transmissions. In addition, the base station may further preferentially use frequencies F₁ and F₂ for grant-based transmissions. Thus, frequency resources F₁ and F₂ correspond to frequencies 606 not recommended for use in unscheduled uplink transmissions, while F₃ and F₄ correspond to frequencies 608 recommended for use in unscheduled uplink transmissions.

As in FIG. 5, during time slot T₁, packets A and X do not collide, since each is transmitted in a different frequency (F₄ and F₁, respectively). However, during time slot T₅, UE2 selects frequency F₃ for transmission of packet B based on the unscheduled assistance information, and therefore, packets B and Y also do not collide. Therefore, the unscheduled assistance information may prevent a collision of packets transmitted from both UEs during the same time slot.

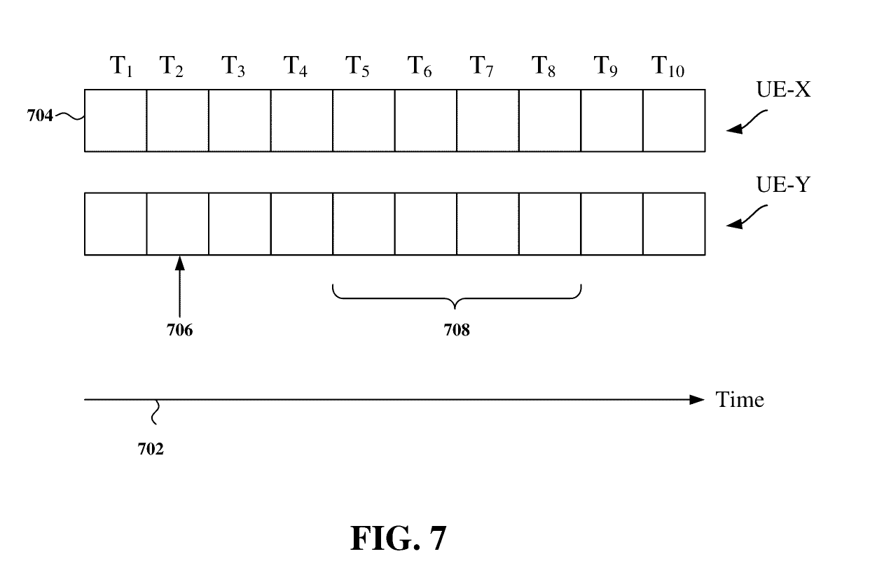

FIG. 7 is a diagram illustrating an example of unscheduled uplink transmissions utilizing time resources that may collide. In the example shown in FIG. 7, a first user equipment (UE-X) has an 8-symbol TTI (transmission time interval) to transmit a packet 704, while a second user equipment (UE-Y) has a 4-symbol TTI to transmit a packet 708. Both UEs (UE-X and UE-Y) are operating in an unscheduled mode and transmit over the same frequency band (i.e., same frequency subcarrier) over time 702 (with time slots T₁-T₁₀ being illustrated for simplicity).

As shown in FIG. 7, UE-X starts the unscheduled transmission of the packet 704 within the 8-symbol TTI over a particular frequency band during time slot T₁. UE-Y receives the packet 708 for uplink transmission during time slot T₂, as indicated by 706 Since UE-Y is unaware of UE-X′s transmission, UE-Y may begin transmitting its packet 708 over the same frequency band at the start of its next 4-symbol TTI, which begins at time slot T₅. However, this results in a collision of the packets 704 and 708 transmitted by the UEs, which may impact their decoding at the base station.

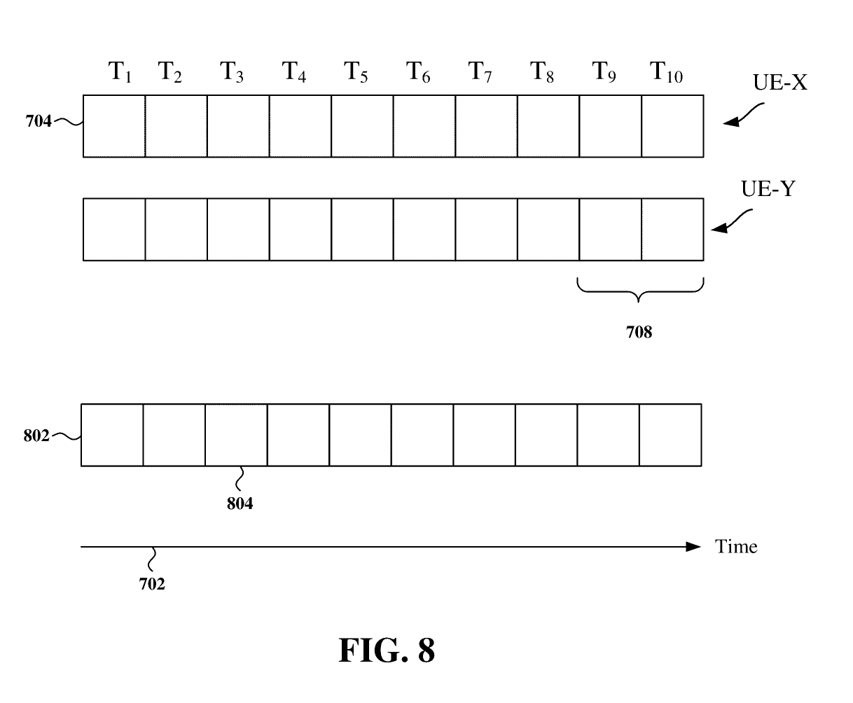

FIG. 8 is a diagram illustrating an example of unscheduled uplink transmissions utilizing time resources selected based on unscheduled assistance information. In the example shown in FIG. 8, UE-X still initiates transmission of its packet 704 during time slot T₁. However, the base station may detect UE-X's transmission in time slot T₂, and transmit a control message 804 including unscheduled assistance information on a control channel 802 to the UEs (UE-X and UE-Y) in time slot T₃, indicating that the frequency band is currently in use until time slot T₈. UE-Y receives the unscheduled assistance information, and based on the indication that the frequency band is in use, may postpone transmission of its packet 708 until time slot T₉ in order to prevent a collision. In other examples, UE-Y may select a different frequency band (i.e., different frequency subcarrier) at time slot T₅ to initiate transmission of its packet to prevent a collision.

Of course, these examples of resources that may be selected for unscheduled uplink transmissions are merely provided to illustrate certain concepts of the invention. Those of ordinary skill in the art will comprehend that these are merely exemplary in nature, and other examples may fall within the scope of the disclosure.

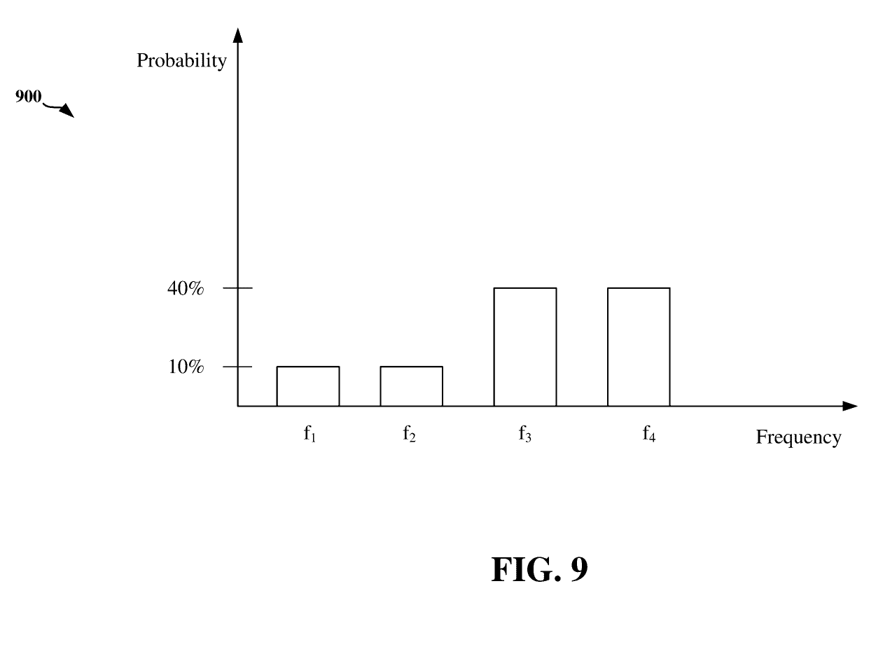

FIG. 9 is a diagram illustrating an example of a probability distribution of recommended resources. In the illustrated probability distribution 900, four frequencies are shown recommended, each having a respective probability associated therewith. For example, the probability distribution indicates the following probabilities for each of the four frequencies (f₁-f₄):

f₁=10%

f₂=10%

f₃=40%

f₄=40%

The subordinate entity may utilize the probability distribution to randomly select one of the four recommended frequencies for an unscheduled uplink transmission. For example, the subordinate entity may randomly select frequency f₁ 10% of the time, randomly select frequency f₂ 10% of the time, randomly select frequency f₃ 40% of the time and randomly select frequency f₄ 40% of the time.

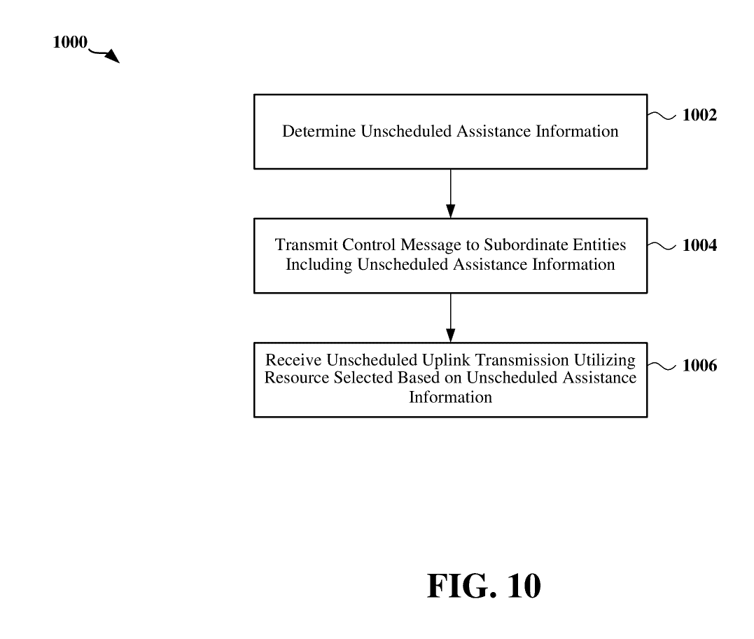

FIG. 10 is a flow chart 1000 of a method for facilitating unscheduled uplink transmissions utilizing unscheduled assistance information. The method may be performed by a scheduling entity 300 as described above and illustrated in FIG. 3, by a processor or processing system, or by any suitable means for carrying out the described functions.

At block 1002, the scheduling entity may determine unscheduled assistance information indicating one or more resources recommended for use by a set of one or more subordinate entities in unscheduled uplink transmissions. The unscheduled assistance information may include, for example, a probability distribution of one or more resources and/or may include time resource information, frequency resource information, transmit power setting information, modulation and coding scheme information, multiple-input-multiple-output (MIMO) pre-coding and rank choice information and/or utilized resource information indicating uplink resources in use for other uplink transmissions. The unscheduled assistance information may be statically configured or dynamically determined based on current scheduled and/or unscheduled resource usage in the cell.

For example, the unscheduled assistance information determination circuitry 344 shown and described above in reference to FIG. 3 may determine the unscheduled assistance information. In some examples, one or more probability distributions, each corresponding to one or more resources, may be determined based on the frequencies (or frequency bands) currently in use for other scheduled or unscheduled uplink transmissions, the quality of the link, the likelihood that a particular time/frequency resource may be utilized, the loading level on each frequency/frequency band and/or other factors. In addition, a different probability distribution may be determined for each subordinate entity to reduce the possibility of collisions between unscheduled uplink transmissions.

At block 1004, the scheduling entity may further transmit a control message including the unscheduled assistance information to the set of subordinate entities. For example, the unscheduled assistance information determination circuitry 344 (shown and described above in reference to FIG. 3) may further provide the unscheduled assistance information to the DL data and control channel generation and transmission circuitry 342 (shown and described above in reference to FIG. 3) for inclusion of the unscheduled assistance information in a control message transmitted on a downlink control channel (e.g., the PDCCH or EPDCCH). The control message may be a unicast message and/or a broadcast message. In addition, the control message may be transmitted within each subframe or in other regular or irregular time intervals.

At block 1006, the scheduling entity may receive an unscheduled uplink transmission from a subordinate entity. For example, the UL data and control channel reception and processing circuitry 343 shown and described above in reference to FIG. 3 may receive the unscheduled uplink transmission. In an aspect, the unscheduled uplink transmission may utilize one or more resources (e.g., time slot, frequency, transmit power and/or MIMO beamforming) selected based on the unscheduled assistance information.

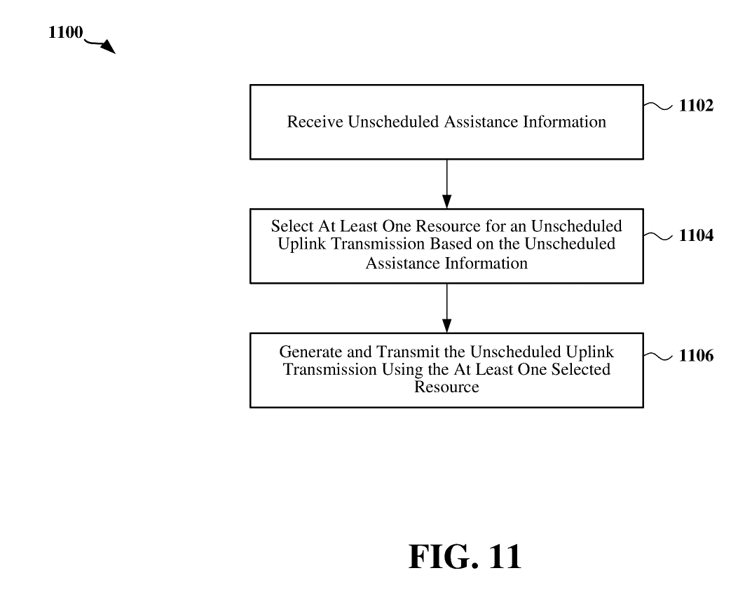

FIG. 11 is a flow chart 1100 of a method for unscheduled uplink transmissions based on unscheduled assistance information. The method may be performed by a subordinate entity 400 as described above and illustrated in FIG. 4, by a processor or processing system, or by any suitable means for carrying out the described functions.

At block 1102, the subordinate entity may receive unscheduled assistance information from a scheduling entity identifying a subset of available resources recommended for use in unscheduled uplink transmissions. For example, the DL data and control channel reception and processing circuitry 444 shown and described above in reference to FIG. 4 may receive the unscheduled assistance information. The unscheduled assistance information may include, for example, a probability distribution of one or more resources and/or time resource information, frequency resource information, transmit power setting information, modulation and coding scheme information, multiple-input-multiple-output (MIMO) pre-coding and rank choice information and/or utilized resource information indicating uplink resources in use for other uplink transmissions.

At block 1104, the subordinate entity may select at least one resource from the available resources for an unscheduled uplink transmission based on the unscheduled assistance information. In some examples, the subordinate entity may select a particular frequency, time slot, transmit power and/or MIMO beamforming setting based on the unscheduled assistance information. For example, the unscheduled resource selection circuitry 447 shown and described above in reference to FIG. 4 may select at least one resource based on the unscheduled assistance information. In one example, the unscheduled resource selection circuitry 447 may utilize the random number generator circuitry 448 (shown and described above in reference to FIG. 4) programmed in accordance with the received probability distribution to select one or more resources.

At block 1106, the subordinate entity may generate and transmit the unscheduled uplink transmission using the at least one selected resource. For example, the UL data and control channel generation and transmission circuitry 442 shown and described above in reference to FIG. 4 may generate and transmit the unscheduled uplink transmission using the selected resources provided by the unscheduled resource selection circuitry 447.

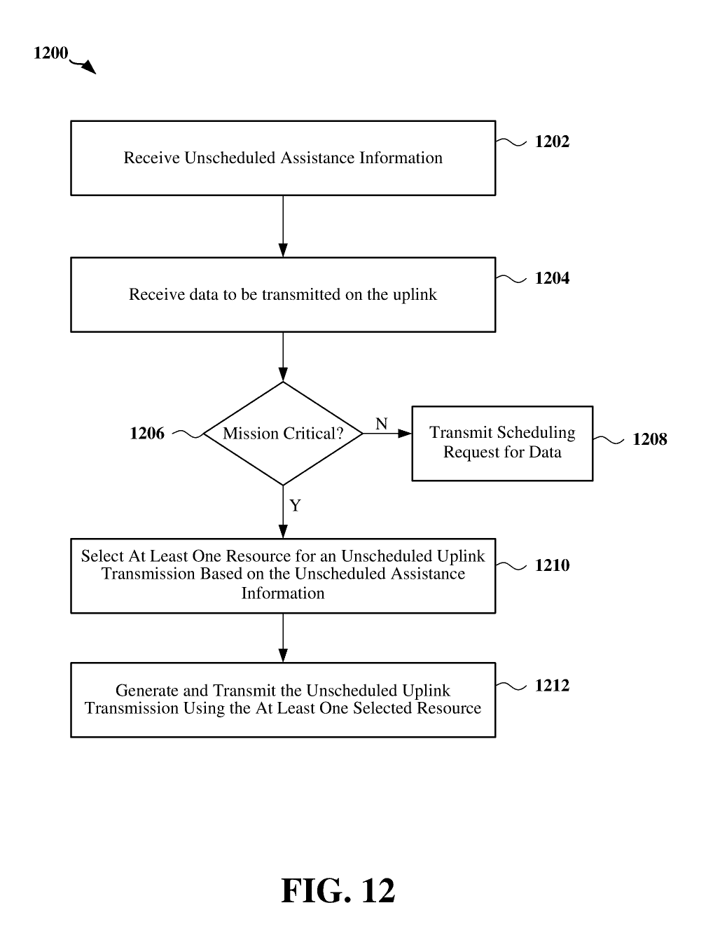

FIG. 12 is a flow chart of another method for unscheduled uplink transmissions based on unscheduled assistance information. The method may be performed by a subordinate entity 400 as described above and illustrated in FIG. 4, by a processor or processing system, or by any suitable means for carrying out the described functions.

At block 1202, the subordinate entity may receive unscheduled assistance information from a scheduling entity identifying a subset of available resources recommended for use in unscheduled uplink transmissions. For example, the DL data and control channel reception and processing circuitry 444 shown and described above in reference to FIG. 4 may receive the unscheduled assistance information. The unscheduled assistance information may include, for example, a probability distribution of one or more resources and/or time resource information, frequency resource information, transmit power setting information, modulation and coding scheme information, multiple-input-multiple-output (MIMO) pre-coding and rank choice information and/or utilized resource information indicating uplink resources in use for other uplink transmissions.

At block 1204, the subordinate entity may receive data from an application to be transmitted to the scheduling entity on the uplink subcarrier. For example, an application running on the subordinate entity may provide data to the unscheduled UL transmission determination circuitry 446 shown and described above in reference to FIG. 4. At block 1206, the subordinate entity may determine whether the data is related to a mission critical application, and therefore, may need to be transmitted via an unscheduled uplink transmission. For example, the unscheduled UL transmission determination circuitry 336 may determine whether the data is delay-sensitive and/or requires high reliability. If the data is not related to a mission critical application (N branch of block 1206), at block 1208 the subordinate entity may generate and transmit a scheduling request to the scheduling entity to request a grant of time-frequency uplink resources for transmission of the data. For example, the UL data and control channel generation and transmission circuitry 442 shown and described above in reference to FIG. 4 may generate and transmit the scheduling request.

However, if the data is related to a mission critical application (Y branch of block 1206), at block 1210, the subordinate entity may select at least one resource from the available resources for an unscheduled uplink transmission based on the unscheduled assistance information. For example, the unscheduled resource selection circuitry 447 shown and described above in reference to FIG. 4 may select at least one resource based on the unscheduled assistance information, using, for example, the random number generator 448, as described above in reference to FIG. 11. In some examples, the subordinate entity may select a particular frequency, time slot, transmit power and/or MIMO beamforming setting based on the unscheduled assistance information. At block 1212, the subordinate entity may generate and transmit the unscheduled uplink transmission using the at least one selected resource. For example, the UL data and control channel generation and transmission circuitry 442 may generate and transmit the unscheduled uplink transmission using the selected resources provided by the unscheduled resource selection circuitry 447.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-6 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-5 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method for transmitting unscheduled uplink transmissions, comprising:
receiving unscheduled assistance information from a scheduling entity, wherein the unscheduled assistance information comprises, for at least a subset of available resources, a respective probability for use in selecting each resource from the subset of available resources;
selecting at least one selected resource from the available resources for an unscheduled uplink transmission based on the unscheduled assistance information; and
transmitting the unscheduled uplink transmission using the at least one selected resource.

2. The method of claim 1, wherein the at least one selected resource comprises at least one of a time slot, a frequency, a transmit power setting, a modulation and coding scheme, or a MIMO beamforming setting.

3. The method of claim 1, wherein the unscheduled assistance information further comprises at least one of time resource information, frequency resource information, transmit power setting information, modulation and coding scheme information, or multiple-input-multiple-output (MIMO) pre-coding and rank choice information.

4. The method of claim 3, wherein the unscheduled assistance information comprises a combination of at least two of the time resource information, the frequency resource information, the transmit power setting information, the modulation and coding scheme information, or the multiple-input-multiple-output (MIMO) pre-coding and rank choice information.

5. The method of claim 1, wherein the unscheduled assistance information further indicates the respective probability for use in selecting one or more of time slots, frequencies, transmit power settings, modulation and coding schemes, or MIMO beamforming settings for unscheduled uplink transmissions.

6. The method of claim 1, wherein the unscheduled assistance information further comprises a non-uniform probability distribution.

7. The method of claim 1, wherein the unscheduled assistance information further indicates the respective probability for use in selecting each combination of two or more of time slots, frequencies, transmit power settings, modulation and coding schemes, or MIMO beamforming settings for unscheduled uplink transmissions.

8. The method of claim 1, wherein the unscheduled assistance information further comprises utilized resource information, the utilized resource information indicating at least one of uplink resources in use for at least one of other scheduled uplink transmissions or other unscheduled uplink transmissions or uplink resources expected to be in use for at least one of other scheduled uplink transmissions or other unscheduled uplink transmissions.

9. The method of claim 1, wherein receiving the unscheduled assistance information from the scheduling entity further comprises:
receiving the unscheduled assistance information from the scheduling entity in a unicast message or a broadcast message.

10. The method of claim 1, wherein receiving the unscheduled assistance information from the scheduling entity further comprises:
receiving a respective control message including respective unscheduled assistance information in each subframe.

11. The method of claim 1, further comprising:
generating the unscheduled uplink transmission in response to determining that data to be transmitted to the scheduling entity relates to a mission critical application.

12. The method of claim 1, wherein the at least one selected resource is outside of the subset of available resources.

13. A user equipment for communicating with a scheduling entity in a wireless communication network, comprising:
a wireless transceiver configured to communicate with the scheduling entity;
a memory; and
a processor communicatively coupled to the wireless transceiver and the memory, the processor configured to:
determine available resources for communicating with the scheduling entity on an uplink carrier;
receive unscheduled assistance information from the scheduling entity via the wireless transceiver, wherein the unscheduled assistance information comprises, for at least a subset of available resources, a respective probability for use in selecting each resource from the subset of available resources for unscheduled uplink transmissions;
select at least one selected resource from the available resources for an unscheduled uplink transmission based on the unscheduled assistance information; and
transmit the unscheduled uplink transmission to the scheduling entity via the wireless transceiver, the unscheduled uplink transmission utilizing the at least one selected resource.

14. The user equipment of claim 13, wherein the at least one selected resource comprises at least one of a time slot, a frequency, a transmit power setting, a modulation and coding scheme, or a MIMO beamforming setting.

15. The user equipment of claim 13, wherein the unscheduled assistance information further comprises at least one of time resource information, frequency resource information, transmit power setting information, modulation and coding scheme information, or multiple-input-multiple-output (MIMO) pre-coding and rank choice information.

16. The user equipment of claim 13, wherein the unscheduled assistance information further indicates the respective probability for use in selecting one or more of time slots, frequencies, transmit power settings, modulation and coding schemes, or MIMO beamforming settings for unscheduled uplink transmissions.

17. The user equipment of claim 13, wherein the unscheduled assistance information further comprises a non-uniform probability distribution.

18. The user equipment of claim 13, wherein the unscheduled assistance information further indicates the respective probability for use in selecting each combination of two or more of time slots, frequencies, transmit power settings, modulation and coding schemes, or MIMO beamforming settings for unscheduled uplink transmissions.

19. The user equipment of claim 13, wherein the unscheduled assistance information further comprises utilized resource information, the utilized resource information indicating at least one of uplink resources in use for at least one of other scheduled transmissions or other unscheduled transmissions or uplink resources expected to be in use for at least one of other scheduled transmissions or other unscheduled transmissions.

20. The user equipment of claim 13, wherein the processor is further configured to receive the unscheduled assistance information by:
receiving the unscheduled assistance information in a unicast message or a broadcast message.

21. The user equipment of claim 13, wherein the processor is further configured to receive the unscheduled assistance information by:
receiving a respective control message including respective unscheduled assistance information in each subframe.

22. The user equipment of claim 13, wherein the processor is further configured to:
generate the unscheduled uplink transmission in response to determining that data to be transmitted to the scheduling entity relates to a mission critical application.

23. A subordinate entity apparatus for communicating with a scheduling entity in a wireless communication network, comprising:
means for receiving unscheduled assistance information from the scheduling entity, wherein the unscheduled assistance information comprises, for at least a subset of available resources, a respective probability for use in selecting each resource from the subset of available resources;
means for selecting at least one selected resource from the available resources for an unscheduled uplink transmission based on the unscheduled assistance information; and
means for transmitting the unscheduled uplink transmission to the scheduling entity, the unscheduled uplink transmission utilizing the at least one selected resource.

24. The subordinate entity apparatus of claim 23, wherein the unscheduled assistance information further comprises at least one of time resource information, frequency resource information, transmit power setting information, modulation and coding scheme information, or multiple-input-multiple-output (MIMO) pre-coding and rank choice information.

25. The subordinate entity apparatus of claim 23, wherein the unscheduled assistance information further indicates the respective probability for use in selecting one or more of time slots, frequencies, transmit power settings, modulation and coding schemes, or MIMO beamforming settings for unscheduled uplink transmissions.

26. The subordinate entity apparatus of claim 23, wherein the unscheduled assistance information further comprises utilized resource information, the utilized resource information indicating uplink resources in use for at least one of other scheduled transmissions or other unscheduled transmissions.

27. The subordinate entity apparatus of claim 23, wherein the means for receiving the unscheduled assistance information further comprises:
means for receiving the unscheduled assistance information in a unicast message or a broadcast message.

28. The subordinate entity apparatus of claim 23, wherein the means for receiving the unscheduled assistance information further comprises:
means for receiving a respective control message including respective unscheduled assistance information in each subframe.

29. A non-transitory computer-readable medium storing computer executable code, comprising code for:
receiving unscheduled assistance information from the scheduling entity, wherein the unscheduled assistance information comprises, for at least a subset of available resources, a respective probability for use in selecting each resource from the subset of available resources;
selecting at least one selected resource from the available resources for an unscheduled uplink transmission based on the unscheduled assistance information; and
transmitting the unscheduled uplink transmission using the at least one selected resource.

30. The non-transitory computer-readable medium of claim 29, wherein the unscheduled assistance information further comprises at least one of time resource information, frequency resource information, transmit power setting information, modulation and coding scheme information, multiple-input-multiple-output (MIMO) pre-coding and rank choice information or utilized resource information indicating uplink resources in use for other uplink transmissions.

31. A method for a scheduling entity to support unscheduled uplink transmissions, the method comprising:
determining unscheduled assistance information comprising, for at least a subset of available resources, a respective probability for use by a set of one or more subordinate entities in selecting each resource from the subset of available resources for unscheduled uplink transmissions;
transmitting a control message including the unscheduled assistance information to the set of one or more subordinate entities; and
receiving an unscheduled uplink transmission from a subordinate entity of the set of one or more subordinate entities, the unscheduled uplink transmission utilizing at least one selected resource from the available resources selected by the subordinate entity based on the unscheduled assistance information.

32. The method of claim 31, wherein the at least one selected resource comprises at least one of a time slot, a frequency, a transmit power setting, a modulation and coding scheme, or a MIMO beamforming setting.

33. The method of claim 31, wherein the unscheduled assistance information further comprises at least one of time resource information, frequency resource information, transmit power setting information, modulation and coding scheme information, or multiple-input-multiple-output (MIMO) pre-coding and rank choice information.

34. The method of claim 33, wherein the unscheduled assistance information comprises a combination of at least two of the time resource information, the frequency resource information, the transmit power setting information, the modulation and coding scheme information, or the multiple-input-multiple-output (MIMO) pre-coding and rank choice information.

35. The method of claim 31, wherein the unscheduled assistance information further indicates the respective probability for use by the set of one or more subordinate entities in selecting one or more of time slots, frequencies, transmit power settings, modulation and coding schemes, or MIMO beamforming settings for unscheduled uplink transmissions.

36. The method of claim 31, wherein the unscheduled assistance information further comprises a non-uniform probability distribution.

37. The method of claim 31, wherein the unscheduled assistance information further indicates the respective probability for use by the set of one or more subordinate entities in selecting each combination of two or more of time slots, frequencies, transmit power settings, modulation and coding schemes, or MIMO beamforming settings for unscheduled uplink transmissions.

38. The method of claim 31, wherein the unscheduled assistance information further comprises utilized resource information, the utilized resource information indicating at least one of uplink resources in use for at least one of other scheduled uplink transmissions or other unscheduled uplink transmissions or uplink resources expected to be in use for at least one of other scheduled uplink transmissions or other unscheduled uplink transmissions.

39. The method of claim 31, wherein transmitting the control message including the unscheduled assistance information to the set of one or more subordinate entities further comprises:
transmitting the control message including the unscheduled assistance information to the set of one or more subordinate entities in a unicast message or a broadcast message.

40. The method of claim 31, wherein transmitting the control message including the unscheduled assistance information to the set of one or more subordinate entities further comprises:
transmitting a respective control message including respective unscheduled assistance information in each subframe.

41. The method of claim 31, further comprising:
receiving additional unscheduled assistance information from another scheduling entity; and
wherein determining the unscheduled assistance information further comprises determining the unscheduled assistance information based on the additional distributed unscheduled assistance information.

42. The method of claim 31, further comprising:
transmitting the unscheduled assistance information to one or more other scheduling entities.

43. A scheduling entity configured to manage wireless communication with a set of one or more subordinate entities in a wireless communication network, comprising:
a wireless transceiver configured to communicate with the set of subordinate entities;
a memory; and
a processor communicatively coupled to the wireless transceiver and the memory, the processor configured to:
determine available resources for communicating with the set of one or more subordinate entities on an uplink carrier;
determine unscheduled assistance information comprising, for at least a subset of the available resources, a respective probability for use by the set of one or more subordinate entities in selecting each resource from the subset of available resources for unscheduled uplink transmissions;
transmit a control message including the unscheduled assistance information to the set of one or more subordinate entities via the wireless transceiver; and
receive an unscheduled uplink transmission from a subordinate entity of the set of one or more subordinate entities via the wireless transceiver, the unscheduled uplink transmission utilizing at least one selected resource from the available resources selected by the subordinate entity based on the unscheduled assistance information.

44. The scheduling entity of claim 43, wherein the at least one selected resource comprises at least one of a time slot, a frequency, a transmit power setting, a modulation and coding scheme, or a MIMO beamforming setting.

45. The scheduling entity of claim 43, wherein the unscheduled assistance information further comprises at least one of time resource information, frequency resource information, transmit power setting information, modulation and coding scheme information, or multiple-input-multiple-output (MIMO) pre-coding and rank choice information.

46. The scheduling entity of claim 43, wherein the unscheduled assistance information further indicates the respective probability for use by the set of one or more subordinate entities in selecting one or more of time slots, frequencies, transmit power settings, modulation and coding schemes, or MIMO beamforming settings for unscheduled uplink transmissions.

47. The scheduling entity of claim 43, wherein the unscheduled assistance information further comprises a non-uniform probability distribution.

48. The scheduling entity of claim 43, wherein the unscheduled assistance information further indicates the respective probability for use by the set of one or more subordinate entities in selecting each combination of two or more of time slots, frequencies, transmit power settings, modulation and coding schemes, or MIMO beamforming settings for unscheduled uplink transmissions.

49. The scheduling entity of claim 43, wherein the unscheduled assistance information further comprises utilized resource information, the utilized resource information indicating at least one of uplink resources in use for at least one of other scheduled transmissions or other unscheduled transmissions or uplink resources expected to be in use for at least one of other scheduled transmissions or other unscheduled transmissions.

50. The scheduling entity of claim 43, wherein the processor is further configured to transmit the control message including the unscheduled assistance information to the set of one or more subordinate entities by:
transmitting the control message including the unscheduled assistance information to the set of one or more subordinate entities in a unicast message or a broadcast message.

51. The scheduling entity of claim 43, wherein the processor is further configured to transmit the control message including the unscheduled assistance information to the set of one or more subordinate entities by:
transmitting a respective control message including respective unscheduled assistance information in each subframe.

52. The scheduling entity of claim 43, wherein the processor is further configured to:
receive additional unscheduled assistance information from another scheduling entity; and
wherein the processor is further configured to determine the unscheduled assistance information by utilizing the additional unscheduled assistance information to determine the unscheduled assistance information.

53. The scheduling entity of claim 43, wherein the processor is further configured to:
transmit the unscheduled assistance information to one or more other scheduling entities.

54. A scheduling entity apparatus configured to manage wireless communication with a set of subordinate entities in a wireless communication network, comprising:
means for determining unscheduled assistance information comprising, for at least a subset of available resources, a respective probability for use by a set of one or more subordinate entities in selecting each resource from the subset of available resources for unscheduled uplink transmissions;
means for transmitting a control message including the unscheduled assistance information to the set of one or more subordinate entities; and
means for receiving an unscheduled uplink transmission from a subordinate entity of the set of one or more subordinate entities, the unscheduled uplink transmission utilizing at least one selected resource from the available resources selected by the subordinate entity based on the unscheduled assistance information.

55. The scheduling entity apparatus of claim 54, wherein the unscheduled assistance information further comprises at least one of time resource information, frequency resource information, transmit power setting information, modulation and coding scheme information, or multiple-input-multiple-output (MIMO) pre-coding and rank choice information.

56. The scheduling entity apparatus of claim 54, wherein the unscheduled assistance information further indicates the respective probability for use by the set of one or more subordinate entities in selecting one or more of time slots, frequencies, transmit power settings, modulation and coding schemes, or MIMO beamforming settings for unscheduled uplink transmissions.

57. The scheduling entity apparatus of claim 54, wherein the unscheduled assistance information further comprises utilized resource information, the utilized resource information indicating uplink resources in use for at least one of other scheduled transmissions or other unscheduled transmissions.

58. The scheduling entity apparatus of claim 54, wherein the means for transmitting the control message including the unscheduled assistance information to the set of one or more subordinate entities further comprises:
means for transmitting the control message including the unscheduled assistance information to the set of one or more subordinate entities in a unicast message or a broadcast message.

59. The scheduling entity apparatus of claim 54, wherein the means for transmitting the control message including the unscheduled assistance information to the set of one or more subordinate entities further comprises:
means for transmitting a respective control message including respective unscheduled assistance information in each subframe.

60. The scheduling entity apparatus of claim 54, further comprising:
means for receiving additional unscheduled assistance information from another scheduling entity; and
wherein the means for determining the unscheduled assistance information further comprises means for determining the unscheduled assistance information based on the additional distributed unscheduled assistance information.

61. The scheduling entity apparatus of claim 54, further comprising:
means for transmitting the unscheduled assistance information to one or more other scheduling entities.
